(19) United States
(12) Patent Application Publication
(10) Pub. No.: US 2009/0027465 A1
(43) Pub. Date: Jan. 29, 2009

(54) WIDE FORMAT INK CARTRIDGE

(76) Inventors: Richard H. Berg, Hilton, NY (US); Dennis M. Lengyel, Hemlock, NY (US); Kevin D. Cowley, Rochester, NY (US)

Correspondence Address: FAY SHARPE LLP, 1100 SUPERIOR AVENUE, SEVENTH FLOOR, CLEVELAND, OH, 44114, US

(21) Appl. No.: 12/179,083

(22) Filed: Jul. 24, 2008

Related U.S. Application Data
(60) Provisional application No. 60/961,779, filed on Jul. 24, 2007.

(51) Int. Cl. B41J 2/175

(52) U.S. Cl. 347/86

(57) ABSTRACT

An ink cartridge has a body having a plurality of side walls forming an internal cavity therein, the internal cavity is substantially filled with ink. An ink supply flow path formed in one of the side walls. An ink supply port is formed in another of the side walls, wherein the ink supply flow path extends to the ink supply port. The side wall having the ink supply port further has one or more angled surfaces for guiding the ink cartridge into a printer. A tab is provided for aligning the cartridge during installation into the printer. A pad is provided to overcome the friction force of installing the cartridge into the printer.

### CLAIM OF PRIORITY

This patent application claims priority from U.S. Provisional Patent Application No. 60/961,779 filed on Jul. 24, 2007, the contents of which are incorporated herein by reference.

### BACKGROUND OF THE INVENTION

The present invention relates to an ink cartridge and an ink cartridge holder. More particularly, the present invention relates to the ink cartridge for supplying ink to a recording apparatus.

Generally, an ink jet recording apparatus is designed to print data by causing the recording head to move back and forth along the width of a recording sheet. Ink is supplied from an ink supply source to the recording head. As a result, the ink jet recording apparatus that must produce a large number of copies must carry a larger-sized ink cartridge which cannot be mounted on a carriage. Thus, the ink cartridge is mounted on the housing of the recording apparatus, and the ink may be supplied to the recording head through a tube.

An ink jet recording apparatus can be provided which includes an ink cartridge holder on which an ink cartridge filled with ink is detachably mounted. A large-size ink cartridge is used for the ink jet recording apparatus which records on large-size papers, such as posters or the like, in order to cope with a large quantity of ink consumption.

The ink cartridge used for the ink jet recording apparatus may be provided with a memory device or chip which stores information, such as a type of ink, color of ink, remaining amount of ink and the like. An information reading section is provided on the ink cartridge holder at a position facing the chip when the ink cartridge is mounted on the ink cartridge holder, and the chip on the ink cartridge and the information reading section on the ink cartridge holder are electrically connected and communicate with each other.

Existing wide format ink cartridges often have a bag or collapsible ink reservoir contained within a rigid housing. An example of such a cartridge is shown in U.S. Pat. No. 6,053,606. A problem with this arrangement is that as the bag collapses, pockets of ink become trapped in the bag, thus reducing the efficiency of the cartridge. Also, air bubbles may form in the ink supply port, and become trapped as well, which may result in imaging defects at the printer. The printer is designed to allow the customer to remove the cartridge to swap out different colors within the same port. Every time the cartridge is re-inserted into the printer, air is injected into the cartridge and positioned within the same compartment where the ink needle will be. This will provide the opportunity for air to be suctioned into the printer's ink line and create imaging defects such as missing jets or the entire color to deprime. Each cartridge insert adds significantly more air into the cartridge, thus, drastically accelerating printing failure. As the ink is consumed from printing, it can be expected that the customer will swap different colors based on the design of the printer. If the cartridge is laid on its side where the ink inlet is at the elevated position, air will enter into the ink fluid channel due to density of the two fluids. Upon re-inserting this cartridge back into the printer's port, the air due to buoyancy will float into the horizontal chambers where the printer's ink needle is located.

Trapped air bubbles in the ink fluid path are suctioned into the printer's ink. This trapped air results in missing jets or depriming of the entire color in the printing images.

There are at least four ways for bubbles to be formed in compartments of the ink fluid flow path of the cartridge. A first way is during ink filling of the cartridge, which may leave initial air bubbles in the fluid path section. If the cartridge is vacuum filled, air will be left behind in the cartridge after filling the cartridge. The air enters into the ink fluid flow path of the cartridge by orientating the air bubbles at the inlet. A second way that air bubbles are formed is during packaging and shipment of the cartridge. A third way is if the cartridge is laid flat on the table, air bubbles will wick into the fluid passage and float forward and possibly deprime the cartridge.

Fourth, as the cartridge is inserted into the printer, the design of the septum or valve in the ink supply port will trap free air as the ink travels from the cartridge to the printer. The rubber septum has a cylindrical cavity but seals to the outer diameter of the printer's ink needle by a compression fit. The nose of the printer's ink needle is typically a tapered cylinder which traps the air in the cylindrical volume of the rubber septum. This trapped air is squeezed into the ink cartridge's fluid compartment(s).

Existing cartridges have a rectangular configuration with all four corners being sharp or squared off. A problem with this configuration is that the square corners design causes some difficulty with inserting the cartridges into the printer. The square corners are likely to catch a front surface of the printer during cartridge insertion. Thus, it is desirable to provide a cartridge which does not have squared off corners.

During insertion of the cartridge into a printer, a spring reaction force is created by an O-ring and spring assembly in the printer. When the cartridge is inserted the O-ring is urged against the cartridge sealing membrane. The spring reaction force may be overcome by a lever arm of the printer which engages a tab on the top of existing cartridges to create an implied spring deformation. This force balance provides added protection coupled with a low diameter rubber O-ring to seal the cartridge to reduce evaporation or other intended functions. Electrical contact registration between the memory device on the cartridge and the printer may be affected by a variance in the tolerance of parts on the cartridge, resulting in the chip becoming mislocated. An improved method of overcoming the spring force is desired and a method of overcoming tolerance stackup misalignment of the memory device is also desired.

Thus, it is desirable to provide an ink cartridge which overcomes the above-mentioned deficiencies and others while providing better and overall more advantageous results.

### SUMMARY OF THE INVENTION

The present invention relates to an ink cartridge. More particularly, it relates to a wide format ink cartridge which has an internal cavity for holding ink without the use of a bag.

In accordance with one aspect of the invention, an ink cartridge has a body including a plurality of side walls forming an internal cavity therein, the internal cavity is substantially filled with ink. An ink supply flow path is formed in one of the side walls. An ink supply port is formed in another of the side walls, wherein the ink supply flow path extends to the ink supply port. The side wall having the ink supply port further has an angled surface for guiding the ink cartridge into an associated printer.

An other aspect of the present invention is the provision of providing a friction member on a bottom surface of the cartridge to overcome a spring force exerted by the printer during installation of the cartridge into the printer.

An other aspect of the present invention is the provision of a tab on the cartridge for compensating for tolerance misalignment of the memory device during installment of the cartridge into the printer.

An other aspect of the present invention is the provision of an ink cartridge which holds ink in an internal cavity without the use of a bag.

Still another aspect of the present invention is the provision of an ink fluid flow path provided between the internal cavity and the ink supply port of the cartridge.

Yet another aspect of the cartridge is the provision of angled surfaces at a front portion of the cartridge for assisting in alignment of the cartridge during installation.

Other aspects of the invention will become apparent upon a reading and understanding of the following detail description.

### BRIEF DESCRIPTION OF THE DRAWINGS

The foregoing advantages of the present invention, and others, will in part be obvious and in part pointed out more fully herein after in conjunction with the written description of the embodiments illustrated in the accompanying drawings in which:

FIG. 1 is a perspective view of a front side of an ink cartridge in accordance with a first embodiment of the present invention;

FIG. 2 is a partial elevational view of a side wall of the ink cartridge of FIG. 1;

FIG. 3 is a front elevational view of a front wall of the cartridge of FIG. 1;

FIG. 4 is a perspective view of the rear side of the cartridge of FIG. 1;

FIG. 5 is a perspective view of an ink cartridge holder which receives the ink cartridge of FIG. 1;

FIG. 6 is a top plan view of an ink cartridge being inserted into the ink cartridge holder of FIG. 5;

FIG. 7 is a top plan view of the ink cartridge of FIG. 1 with the cover removed;

FIG. 8 is a perspective view of the ink cartridge of FIG. 1 showing the cover installed;

FIG. 9 is a side elevational view of a cartridge with a friction member in accordance with an alternate embodiment of the present invention;

FIG. 9A is an enlarged view of the bottom wall and friction member of FIG. 9;

FIG. 10 is a partial perspective view of an ink cartridge in accordance with an alternate embodiment of the present invention; and

FIG. 11 is an enlarged view of a tab on the cartridge of FIG. 10 in accordance with an alternate embodiment of the present invention.

### DETAILED DESCRIPTION OF THE INVENTION

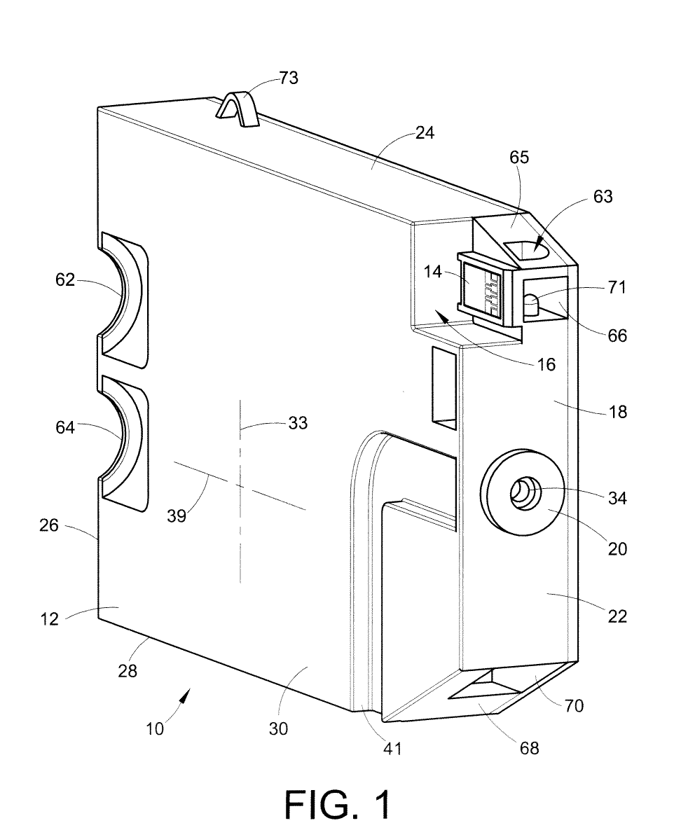

Referring now in greater detail to the drawings, wherein the showings are for the purpose of illustrating preferred embodiments of the invention only and not for the purpose of limiting the invention, FIG. 1 is a front perspective view of the ink cadge according to the first embodiment of the present invention An ink cartridge 10 according to the first embodiment includes an ink cartridge main body 12 having a substantially rectangular parallel piped shape, an information storing unit 14 provided on a recess 16 which is adjacent a first side or a first wall 18 of the ink cartridge main body, and an ink supply units 20 provided on a front surface 22 of wall 18. The body is formed by rigid side walls 18, 24, 26, 28 and wall 30.

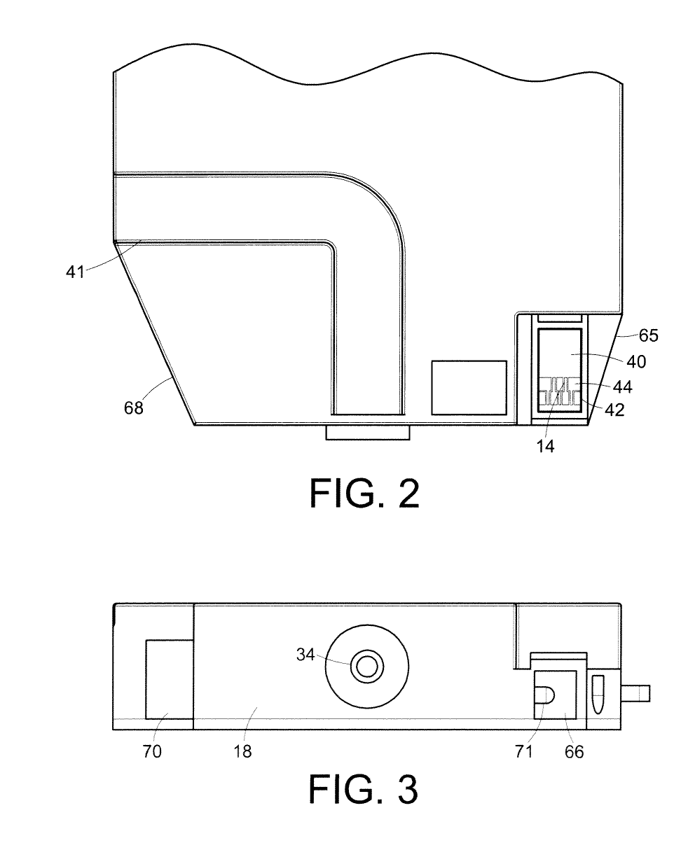

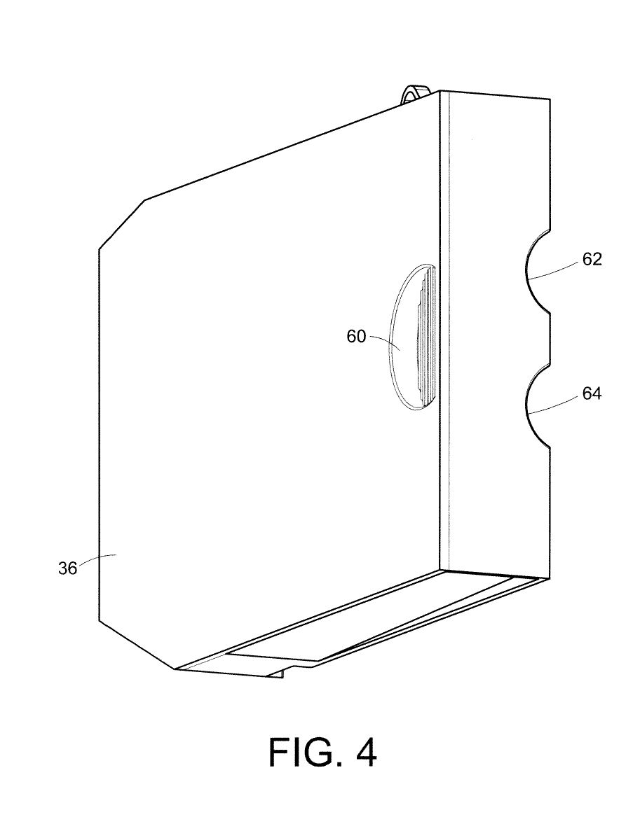

The ink cartridge main body includes a cavity 32 with one side being open, an ink supply port 34 (FIG. 3) provided at end 18 and is fixed to end wall 18, and a substantially flat cover plate 36 (FIG. 4). In this ink cartridge main body, the internal supply port is provided in a recess 41 (FIG. 2) of wall 30. The flow path 38 is provide in wall 30 which is substantially perpendicular to wall 18. The channel 38 has a first, strait portion 31 extending along a first axis 33 of the body and a curved portion 35 connecting a second straight portion 37 extending perpendicular to first portion 31 and along second axis 39 of the body. The cover is fixed to the side walls 18, 24, 26, 28 of the container main body, such as by vibration, welding, or the like, with the internal cavity 32 of the container being enclosed by the cover. Thereby, a large quantity of ink is held and the large quantity of the ink is supplied to the ink jet recording apparatus stably which records on large-size papers such as posters or the like.

The information or memory storing unit 14 of the ink cartridge stores information, such as a type of ink and the ink cartridge, color of the ink in the ink cartridge, and remaining amount of the ink. For example, as shown in FIG. 2, the information storing unit is a contact type chip. The contact type chip includes a substrate 40, a connection electrode section 42 including a plurality of connection terminals 44 which are exposed to the front surface of the substrate, and memory including a semiconductor memory element, such as EEPROM provided on a back side of the substrate. The information data in the memory is read or rewritten through the connection terminals 44 electrically connecting with connection electrodes of the recording apparatus. In the present embodiment, the information storing or memory unit is of a contact type which is provided with the connection electrode section 42 including the plurality of connection terminals 44 exposed outside.

Seven connection terminals are typically arranged adjacent each other in the present embodiment as shown in FIG. 2. Alternatively, for example, the memory of the information storing unit may be provided on the other wall of the cartridge main body or the like and connects with the connection electrode section, which is provided on the first wall, via a flexible print circuit (FPC).

The recess 16 may be provided adjacent the first wall 18 of the ink cartridge main body as shown in FIG. 2. The information storing or memory unit and the connection electrode section are arranged in the recess. Moreover, since the upper part of the connection terminal surface is opened to the outside in the recess, the information storing unit is easily mounted on the ink cartridge main body during manufacturing of the ink cartridge.

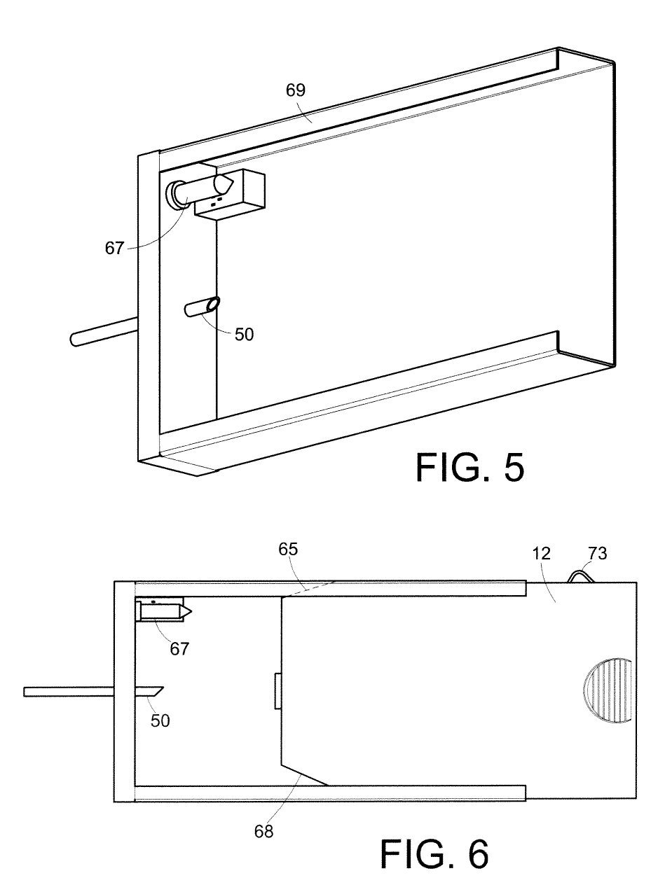

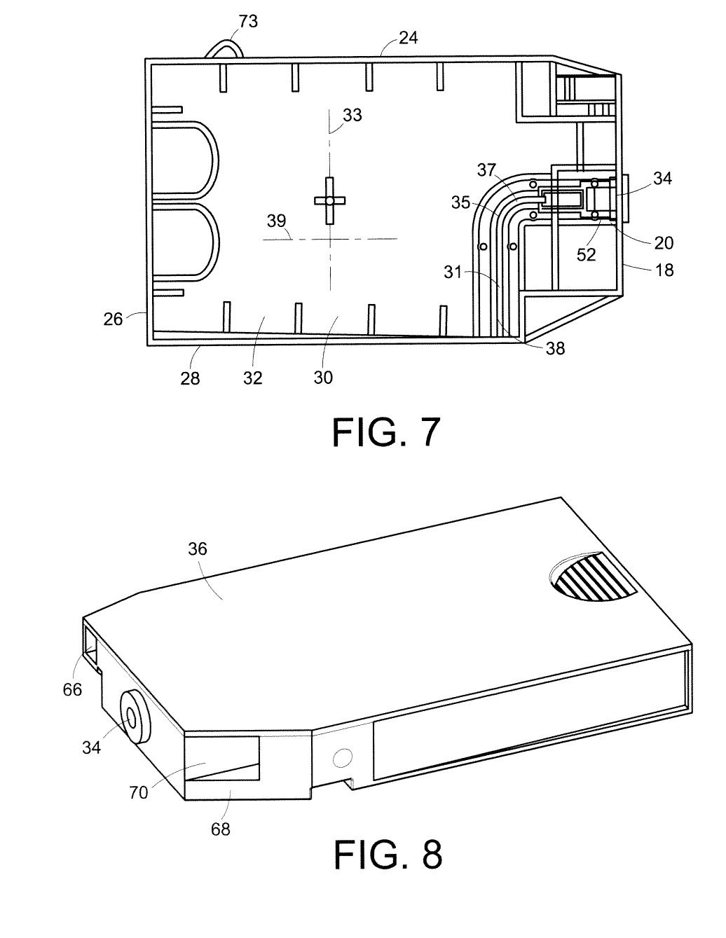

The ink supply port 34 is provided in the ink supply section of the ink cartridge, and the ink is supplied to the recording apparatus main body from the ink cartridge through the ink supply port. An ink supply needle 50 (FIG. 6) of the recording apparatus is inserted in the ink supply port. A valve or septum 52 (FIG. 7), which can be perforated or have a slit, is penetrated by insertion of the ink supply needle, and is provided within the ink supply port.

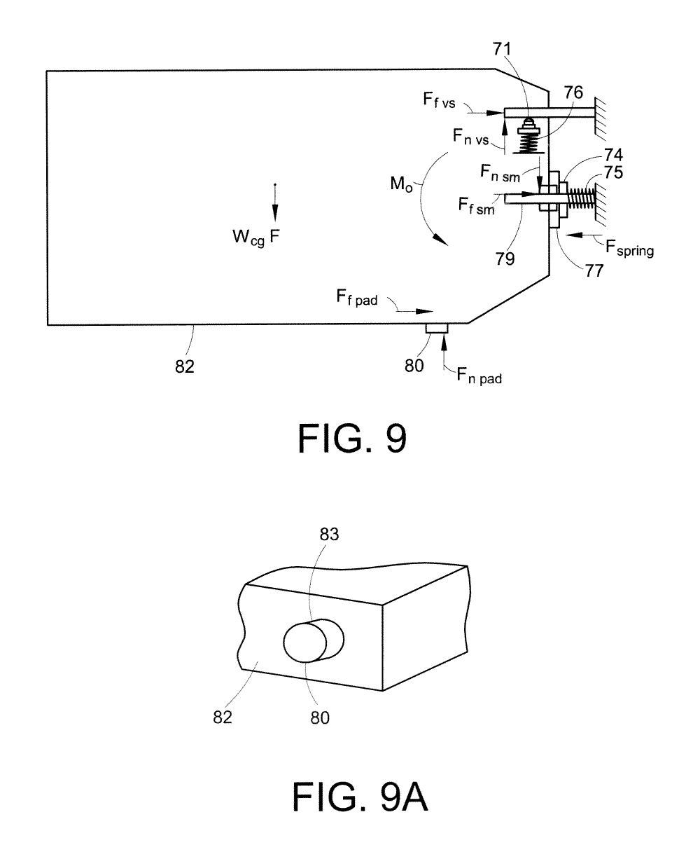

Referring to FIG. 4, in the rear side of the ink cartridge, there includes a gripping portion 60 and two finger indentations or recesses 62, 64 for enabling a user to securely grip the ink cartridge, and to easily attach/detach the ink cartridge to/from the ink cartridge holder of the ink jet recording apparatus. Referring to FIGS. 1, 3 and 8, at a front end of the cartridge, the cartridge further has a substantially square-shaped opening 66 positioned adjacent the memory unit into which a positioning rod 67 (FIG. 5) of the ink cartridge holder 69 may extend. A spring biased pin 71 may be depressed and keep a positioning rod aligned within opening 66. An angled or sloped surface 65 is formed adjacent opening 66 and the memory device 14. On the other side of the cartridge, a second angled or sloped surface 68 is formed at a lower corner in which a slotted opening 70 is formed. A second positioning member (not shown) of the ink cartridge holder may extend into the slotted opening. A projecting member 73 (FIGS. 1, 7) extending from side wall 24 helps guide and align the cartridge into its holder. The projecting member may be flexible or biased. The angled surfaces 65 and 68 at an upper corner and at a lower corner help align, locate and center the cartridge and guide it into the holder as it is inserted as seen in FIG. 6. The upper angled wall also serves as a shield for the cartridge venting mechanism (pin 71 and spring 76 (FIG. 9)) which may allow ink to escape if depressed prior to insertion into the printer. A recess 63 is also provided for the venting mechanism to catch any ink that may leak from around the vent seal during insertion.

Referring to FIG. 6, the front surface of the cartridge is inserted into the holder main body of the ink cartridge holder. Positioning members of the holder oppose opening 66 and slotted opening 70. The ink supply needle 50 of the holder is positioned opposite the ink supply port 34 of the ink cartridge. The ink cartridge is slid into the holder cavity until the connection electrodes of the information reading section of the holder controls connection terminals of the connection electrode section of the information sharing unit in the ink cartridge.

Referring to FIG. 9, a printer has an O-ring 74 with a spring 75 attached behind it so when the cartridge is inserted the rubber O-ring is urged against a cartridge sealing membrane 77.

In accordance with one embodiment of the present invention a friction member or pad 80 is provided on one of the side walls such as bottom wall 82 of the cartridge. The friction pad is provided to overcome the spring force exerted by the spring 75 of the printer and the friction of cartridge installation. As seen in FIG. 9A, the bottom wall of the cartridge may be milled to create a hollow hole 83, such as a cylindrical hole for installing a friction pad. The pad may be staked into the hole or otherwise secured or fastened to the cartridge wall. The pad can be fabricated of various materials, such as metal, rubber, felt or foam.

As seen in FIG. 9, a free body diagram is illustrated to show that the spring force F_{spring} exerted by spring 75 can be greater than the stiffness of the cartridge sealing membrane 77 (sm) (F_{F sm} and F_{n sm}) and the vent spring 76 (vs) (F_{F} vs +Fₙ vs) which biases pin 71 of the cartridge depending on the coefficient of friction of ink needle 79 coupled with the tolerance of the vent spring. By adding the friction pad, the bottom of the cartridge makes contact with a sheet metal surface in the printer which effectively reduces the moment arm Mo that is exerted about the ink needle as a function of the ink cartridge's weight. By providing a normal force Fₙ at the friction pad coupled with a high coefficient of friction with a friction force F_{F} will effectively allow the sum of the frictional components (F_{f} vs +F_{f} sm+F_{F} pad) to be greater than the printer's spring force F_{spring}. The result is the percentage of the cartridge weight (W_{cg}) and the interference with the sheet metal counteracts the spring force at the ink needle.

During installation of the cartridge into a printer, electrical contact registration may be affected by tolerance stackup variations in the cartridge's components. As a result, the memory device or chip 14 may be mislocated, such as by molding process tolerances or the cartridge position having an angular misalignment during installation into the printer.

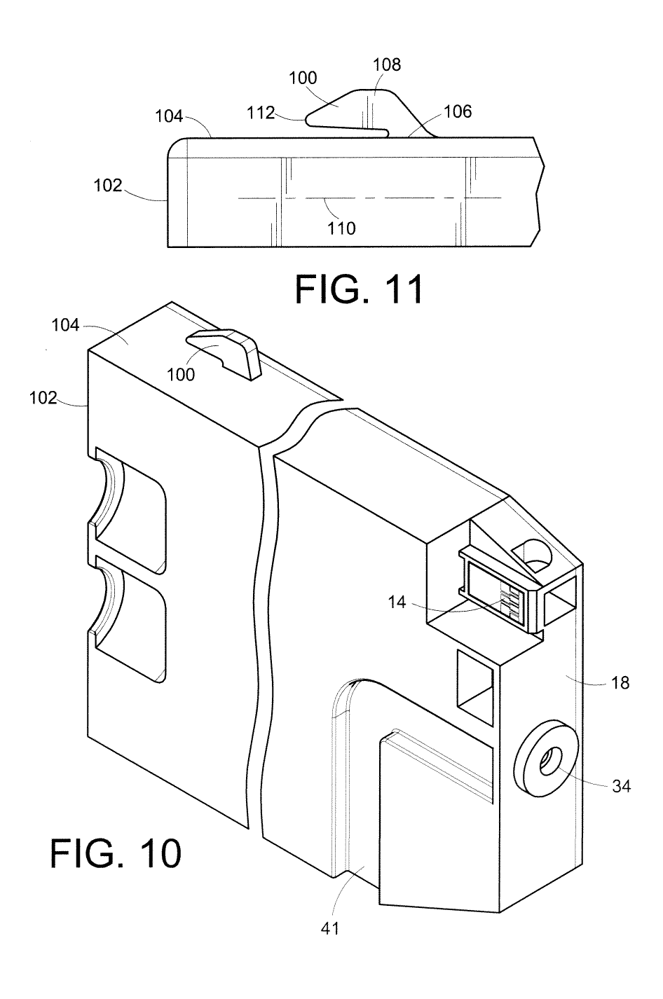

Referring to FIGS. 10 and 11, in accordance with another embodiment of the invention, to counter angular misalignment or variation of the cartridge, a boss or tab 100 such as a biasing member is provided near the end 102 of the cartridge on a top end 104 of the cartridge. The tab may be biased or compliant. The tab facilitates alignment of the memory device or chip with the electrical contact in the printer. The tab aids in alignment of the center line of the chip with the center line of the electrical contact. The preferred height of the tab is between 5 and 6 mm. The preferred width is around 5 mm, and the length is around 14 mm.

The tab helps center the electrical contacts vertically, and insertion and withdrawal of the cartridge is much smoother than with a rigid tab which results in the chip being significantly off center with respect to the printer electrical contact. The compliant tab also aids in maintaining electrical contact, more so than a rigid tab.

The tab or boss has a first portion 106 which extends from the cartridge top wall and a second portion 108 which extends along a longitudinal axis 110 of the cartridge. As the cartridge enters the holder, the boss or tab deflects or is biased downwardly by an upper wall of the holder, such that tip 112 moves toward top wall 104.

The result is that the memory device is centered with respect to the electrical contact of the printer and the cartridge remains aligned as the cartridge is installed.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An ink cartridge comprising:
a body comprising a plurality of side walls forming an internal cavity therein, said internal cavity substantially filled with ink;
an ink supply flow path formed in one of said side walls;
an ink supply port formed in another of said side walls, wherein said ink supply flow path extends to said ink supply port; and
a first angled surface provided adjacent said side wall comprising said ink supply port for guiding said ink cartridge into an associated printer.

2. The ink cartridge of claim 1, which said angled surface comprises an elongated opening.

3. The ink cartridge of claim 1, further comprising a member secured to one of said side walls of said cartridge for frictionally engaging a surface of said printer.

4. The ink cartridge of claim 1, further comprising a cover secured to said plurality of side walls for enclosing said internal cavity.

5. The ink cartridge of claim 1, wherein said ink supply flow path comprises a first, straight portion, a second straight portion and a third, curved portion connecting said first and second straight portions.

6. The ink cartridge of claim 1, wherein said internal cavity is formed by rigid walls.

7. The ink cartridge of claim 1, further comprising a tab extending from one of said side walls of said cartridge.

8. The ink cartridge of claim 7, wherein said tab is formed of flexible material.

9. The ink cartridge of claim 3, further comprising a tab extending from one of said side walls of said cartridge.

10. The ink cartridge of claim 9, wherein said tab is formed on one of said side walls which is opposite said side wall on which said friction member is secured.

11. The ink cartridge of claim 1, wherein said ink supply flow path comprises a channel.

12. The ink cartridge of claim 3, wherein said one of said side walls comprises an opening for securing said member.

13. The ink cartridge of claim 7, wherein said tab comprises a first portion and a second portion of flexible material, wherein said second portion deflects as said ink cartridge is installed in a printer.

14. The ink cartridge of claim 3, wherein said member is made of one of the materials, metal, foam or felt.

15. The ink cartridge of claim 3, wherein said member comprises a friction pad.

16. The ink cartridge of claim 1, further comprising a second angled surface formed adjacent said side wall comprising said ink supply port, said first and second angled surfaces formed adjacent opposite ends of said side wall comprising said ink supply port.

17. The ink cartridge of claim 16, wherein said second angled surface comprises a recess for a venting mechanism for said ink cartridge.
